(19) United States
(12) Patent Application Publication
(10) Pub. No.: US 2008/0098525 A1
(43) Pub. Date: May 1, 2008

(54) Patient positioning apparatus

(76) Inventors: Stefan Doleschal, Grafenwohr (DE); Tobias Hoth, Pegnitz (DE); Paul Weidner, Pressath (DE)

Correspondence Address: BRINKS HOFER GILSON & LIONE, P.O. BOX 10395, CHICAGO, IL, 60610, US

(21) Appl. No.: 11/980,061

(22) Filed: Oct. 30, 2007

(30) Foreign Application Priority Data
Oct. 31, 2006 (DE) DE102006051881.0

(51) Int. Cl. A61G 7/08; A61G 7/00

(52) U.S. Cl. 5/600; 901/50

(57) ABSTRACT

The patient positioning apparatus features a patient bed able to be moved by a motorized drive under the control of a control device. A sensor device is provided for detection of a manual force acting on the patient bed to move it. The control device is configured so that it activates the drive as a function of the force detected. In this way a simple method of supporting the manual movement of the patient bed by the drive is achieved.

The present patent document claims the benefit of the filing date of DE 10 2006 051 881.0 filed on Oct. 31, 2006, which is hereby incorporated by reference.

### BACKGROUND

The present embodiments relate to a patient positioning apparatus.

A patient positioning apparatus positions a person lying on a patient bed in the effective range of a medical diagnosis or therapy device. The effective range for a medical diagnostic imaging device, such as a computer tomography device or an x-ray device, is the scan range in which the person must be positioned in order to create a diagnostic image of a region of the body. The effective range for a therapy device is the region of the body able to be detected by the therapy device. For example, the effective range for a radiation therapy device is the region of the body able to be detected by x-ray radiation generated by the radiation therapy device.

A control device is used to change the position of the patient bed. The control devices uses a control signal to activate a drive for motorized movement of the patient bed. A computer program or an input aid (device) may be used to position the patient bed. The input aid (device) may include a joystick, with a computer keyboard, a touch screen or a computer mouse. The input aid transfers the positioning information to the control device. Using the input aid, the person lying on the patient bed is able to be positioned without any force being exerted. Movement to a number of positions, one after the other, may be automated. This is, for example, of significance in computer tomography if a number of images are first to be recorded as a type of image sequence and are subsequently to be computed jointly to form merged image information.

The positioning information is entered indirectly via the input aid. An operator checks the positioning information entered via the input aid with reference to the actual position to which the bed is moved to make sure that it is correct, for example, by constant visual contact with the patient bed. Multiple attempts may be needed to arrive at the desired position.

The patient bed may be moved manually. The manual movement may be easy, such as when it is only necessary to move the patient bed to one individual position, for example, for the measurement of individual medical x-ray image information by an x-ray device, For manual movement, however, an operator must overcome the resistance of the drive, especially the resistance of the motor and transmission.

DE 199 29 654 C1 discloses an electromagnetic or manual clutch for coupling the drive to the patient bed. The electromagnetic or manual clutch is used to facilitate manual movement of the patient bed despite the drive being coupled to the bed. If the patient bed is to be moved manually, the bed is decoupled from the drive by the clutch, so that only the frictional forces of, for example, a patient bed support embodied as a linear guide have to be overcome. The clutch must be released by a manual activation. The clutch involves a considerable additional constructional outlay.

DE 10 2004 047 615 B3 discloses coupling the motorized drive and the patient bed elastically to each other. A position sensor compares the actual position of the patient bed and the position of the motorized drive with each other. If the two positions differ and the motorized drive is simultaneously switched off, the patient bed has been moved by an operator.

### SUMMARY

The present embodiments may obviate one or more of the drawbacks or limitations inherent in the related art. For example, in one embodiment, a patient positioning apparatus supports manual movement of the patient bed by the motorized drive and can be implemented in a simple and cost-effective way.

In one embodiment, a patient positioning apparatus includes a sensor device that detects a manual force acting on the patient bed to move the patient bed. A control device controls the drive as a function of the force detected. The sensor device may include a force transducer that measures the force operating on the transducer by strain gage technology.

The strain gage technology may include a force transducer having an elastic sprung body. One or more strain gages are applied to the elastic sprung body. The one or more strain gages detect a deformation of the sprung body as a result of the effect of a force. When acted on by a force, one or more strain gages generate a measuring signal in the form of an electrical voltage. The measuring signal may be tapped off in a simple manner.

A force transducer has a low cost. The strain gage technology is widely developed. Force transducers with almost any measurement range and with almost any given sensitivity are available on the market as standard devices.

The control device may be detect and process the electrical measuring signal. The control device may generate a control signal with reference to stored program logic, which drives the motorized drive to support the force applied to the patient bed.

The patient bed may be moved by the drive and moved manually. No separate clutch for decoupling of patient bed and drive is necessary. When moving a patient bed manually, an operator only has to overcome the frictional forces of a guide assigned to the patient bed. Manual movement is assisted by the drive. The drive may be a self-arresting linear drive, for example, a threaded spindle. Even with the self-arresting linear drive, a manual movement may be implemented. In contrast to the conventional clutch, the resistance to movement of the drive elements, for example, of toothed belts or spindles, is removed.

In one embodiment, the sensor device detects a relative force between the drive and the patient bed. If a relative force is measured, no separate calculation of the forces acting on the drive and on the patient bed is necessary.

The sensor device may be disposed between the drive and the patient bed. The force sensors may be equally loaded for tensile and compressive forces, which have two threaded connections for introduction of forces. The force sensors may be positioned by screw connections in an interference fit between the motor drive and the patient bed. Since the force transducer may be subjected to tensile and compressive forces, the force transducer may be mounted at almost any location. The force transducer is operable to measure the relative force between motorized drive and patient bed.

In one embodiment, the control unit controls the drive only when the threshold of a force acting on the patient bed is exceeded. Light and accidental (minimal) contacts with the patient bed by the operator or movements of the person lying on the patient bed do not lead to a change in the position of the patient bed. When the operator lets go of the patient bed the patient bed comes to a halt because the force falls below the threshold value.

The control unit may control the drive so that the force between a drive axis driven by the drive and the patient lies (maintained) below a predetermined tolerance value. The drive axis involves a toothed belt drive, for example. The sensitivity in the control of the motorized drive may be attenuated. The measurement signal may vary slightly as a result of uneven application of manual force by the operator or because of movement of the person lying on the patient bed during the movement do not lead to a change of direction of movement or speed of movement of the patient bed.

In one embodiment, the force is measured and the drive activated iteratively, for example, at regular intervals. A closed-loop control circuit may be checked iteratively with the program logic. The program logic may determine a change of the force is present and how the drive is to be controlled to support a movement of the patient bed in a specific direction.

The force may be measured and averaged at a high measurement cycle (frequency). Fluctuations of the measurement signal and of the manual force acting on the patient bed may be compensated for because of the high measurement cycle. The control of the motorized drive may be undertaken with a lower cycle, to avoid abrupt changes with respect to the speed of movement and the direction of movement. This allows an even movement of the patient bed to be achieved despite an uneven effect of the force.

The patient bed may include a guide. The guide may be a linear guide. A linear guide enables a one-dimensional or two-dimensional displacement movement. The ease of movement of the patient bed may be predetermined via the choice of linear guide. Linear guides may be combined with one another in accordance with the building block principle. Linear guides are available on the market in a variety of versions at a low cost.

In one embodiment, a patient positioning apparatus includes a positioning robot as a guide for the patient bed. The positioning robot may include a number of pivot arms linked by swivel joints. The pivot arms may move the patient bed to almost any position in the space. The pivot arms may adjust the patient bed in the vertical direction and tilt the patient bed.

### BRIEF DESCRIPTION OF THE DRAWINGS

FIG. 1 illustrates one embodiment of a patient positioning apparatus, and

FIG. 2 illustrates the timing of one embodiment of a measurement signal and a control signal in a time-force diagram

### DETAILED DESCRIPTION

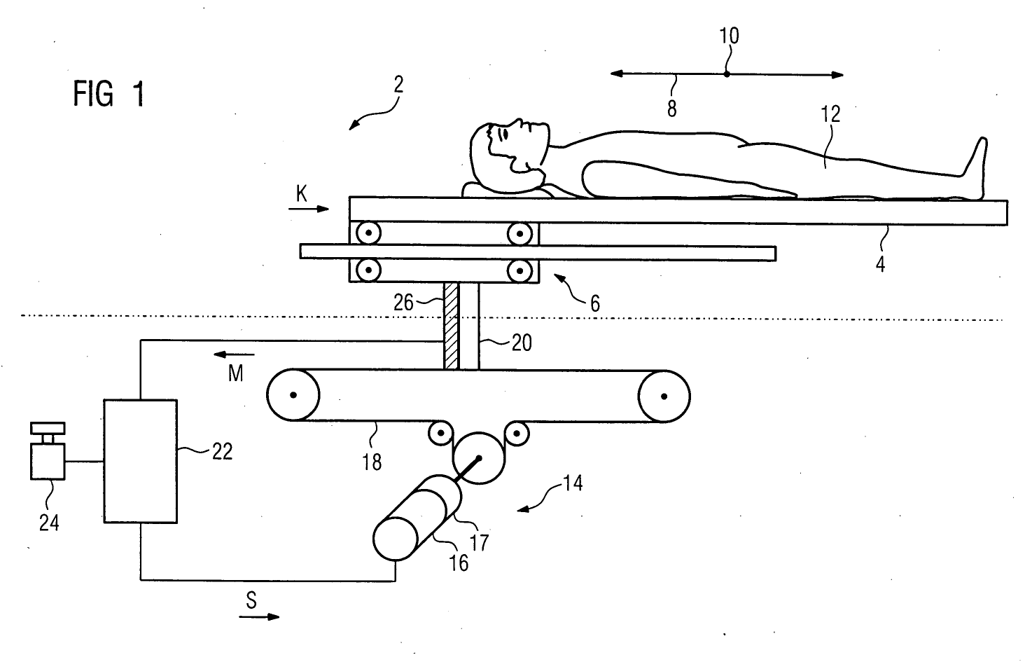

In one embodiment, as shown in FIG. 1, a patient positioning apparatus 2 includes a patient bed 4 that can be moved by a linear guide 6 in the longitudinal direction 8 and the transverse direction 10. The patient positioning apparatus 2 may be used to position a person 12 lying on the patient bed 4 in the effective range of a medical diagnosis or therapy device.

A motorized drive 14 is used to position the person 12. The motorized drive 14 includes an electric motor 16, a transmission 17 and drive axis 18 driven by the transmission 17. As shown in the exemplary embodiment shown in FIG. 1, the drive axis 18 is a toothed belt. To move the patient bed 4, the transmission 17 is coupled by a coupling element 20 to the linear guide 6. A control device 22 controls the electric motor 14. The control device 22 may predetermine speed of travel and direction of travel of the patient bed 4 using a control signal S.

The patient bed 4 may be positioned automatically by the control device 22. Using the automatic positioning, a medical diagnosis device, such as a computer tomography, may measure successive two-dimensional image information and merge in an evaluation unit the two-dimensional image information into three-dimensional image information.

In one embodiment, the patient positioning apparatus 2 includes input aids. The input aids may be used to manually position the patient bed 4. The input aids may include, for example, a joystick 24. The movement of the joystick 24 in a longitudinal direction 8 or transverse direction 10 is converted into a corresponding movement of the patient bed 4.

In one embodiment, a sensor device 26 is coupled to the coupling element 20 in an interference fit. The sensor device 26 detects a manual force K acting on the patient bed 4. Since the sensor device 26 is arranged between the drive axis 18 and the linear guide 6, the sensor device 26 may measure the relative force arising between the transmission 16 and the linear guide 6 during manual movement of the patient bed 4. The sensor device 26 generates a measuring signal M, which is detected and processed by the control device 22. The sensor device 26 is, for example, a force transducer with strain gage technology.

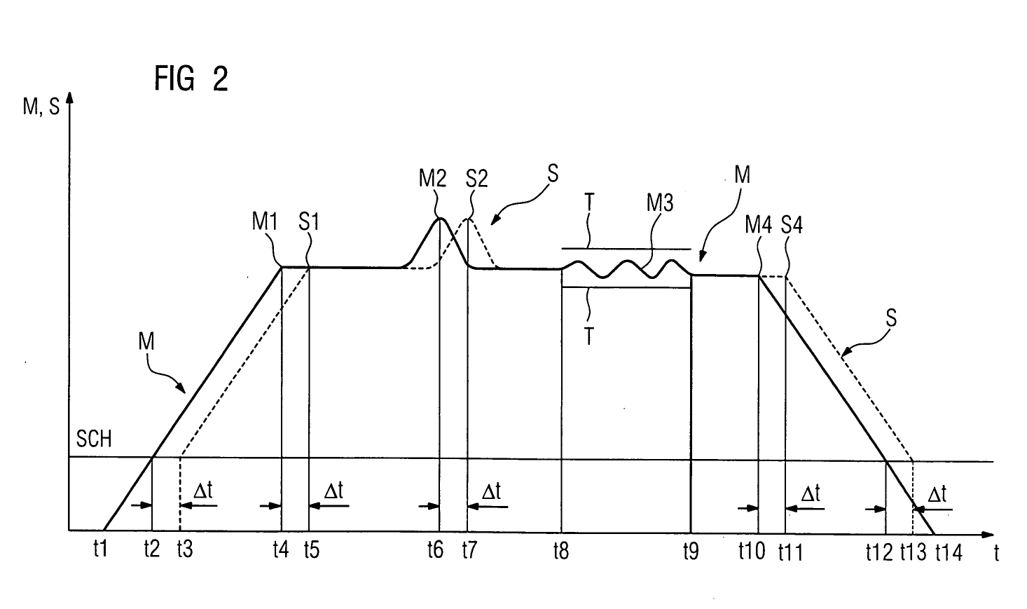

In one embodiment, the patient bed 4 is positioned automatically. The measuring signal M is not processed in the control device 22 if the patient bed 4 is positioned automatically. The measurement signal M is only processed if the patient positioning apparatus 2 is in a standby position. Accordingly, the patient bed 4, for example, can be positioned using the joystick 24. If a manual force is exerted on the patient bed 4, the relative force is measured between the drive axis 18 and the linear guide 6. The relative force has amount and direction information. If the amount information exceeds a threshold value SCH, for example, as shown in FIG. 2, the control device 26 generates a control signal S for activation of the electrical drive 14. The threshold value SCH may be used to pre-specify the sensitivity of the control.

The control device 22 may detect iteratively the measuring signal M at defined intervals. The electrical drive 14 is activated until the measuring signal M for the relative force falls below the threshold value SCH. The measuring signal M for the relative force falls below the threshold value SCH occurs when the operator lets go of the patient bed 4. The displacement process is ended and the new position of the patient bed 4 is reached.

During the displacement process, the control signal S may be iteratively adapted to the measuring signal M for the measured relative force in a type of closed-loop control procedure. A differing control signal may be only generated if the relative force lies above a tolerance threshold T. Even displacement of the patient bed 4 may be achieved. An operator may be assisted by the drive 14 when exerting the manual force K.

The manual force K acting on the patient bed 4 includes a longitudinal direction 8 component and a transverse direction 10 component. The resultant relative force is measured by the sensor device 26 and transmitted as a measuring signal M to the control device 22. The measuring signal M includes a longitudinal direction 8 component and a transverse direction 10 component. To control the drive 14, the control device generates a control signal S having a longitudinal direction 8 component and a transverse direction component.

FIG. 2 shows one embodiment of a diagram for a displacement process. In FIG. 2, the absolute amounts for the measuring signal M proportional to the manual force K and the control signal S generated by the control device 22 are represented as functions of time. The measuring signal M is plotted as a solid line and the control signal S is a dashed line.

The manual force K acts on the patient bed 4, which causes the measuring signal M to increase from time t1 up to a final value M1 at time t4. The threshold value SCH is exceeded at time t2. The delay Δt corresponds to the speed of processing of the control device 22 for detection and calculation of the measurement signal M and the generation of the control signal S. With the delay Δt, the control device 22 generates the control signal S for activating the drive 14 from time t3 onwards. From the beginning, the control signal S has the threshold value SCH and follows the measuring signal M for the manual force K until it reaches the final value S1 at time t5, with the time delay Δt in relation to the final value M1 of the measurement signal M at time t4.

At time t6, the manual force K increases. The measuring signal M increases to the value M2. This value will be reproduced by the control unit 22 as signal value S2 with the time delay Δt at time t7.

From time t8 to time t9, the manual force K and the measuring signal M fluctuate. In FIG. 2 this time interval is labeled M3. The fluctuation of the measurement signal M lies in the positive and in the negative tolerance threshold T, so that no change to the control signal S occurs. An even displacement movement of the patient bed 4 may be achieved.

At time t10 and beyond, the manual force K falls, for example, since the operator lets go of the patient bed 4. The measuring signal M falls from its momentary value M4 at time t10 to the value 0 at time t14. The control device 22 generates a corresponding signal S which falls with the time delay Δt from time t11 from its momentary value S4. At time t12, the value falls below threshold value SCH. With the time delay Δt the amount of the control signal S is equal to 0 at time t13, for example, the drive 14 is no longer activated. The patient bed 4 stops although a relative force which differs from 0 is still measured until time t14.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A patient positioning apparatus comprising:
a patient bed movable in a motorized manner via adrive;
a sensor operable to detect a manual force acting on the patient bed; and
a control unit operable to activate the drive,
wherein the control device is operable to activate the drive as a function of the detected manual force.

2. The patient positioning apparatus as claimed in claim 1, wherein the sensor device is operable to detect a relative force between the drive and the patient bed.

3. The patient positioning apparatus as claimed in claim 1, wherein the sensor device is disposed between the drive and the patient bed.

4. The patient positioning apparatus as claimed in claim 1, wherein the control unit is operable to activate the drive when a threshold value of the force acting on the patient bed is exceeded.

5. The patient positioning apparatus as claimed in claim 1, wherein the control unit is operable to activate the drive so that the force between a drive axis and the patient bed is below a predetermined tolerance value.

6. The patient positioning apparatus as claimed in claim 1, wherein the manual force is iteratively measured.

7. The patient positioning apparatus as claimed in claim 1, wherein the guide is a linear guide.

8. The patient positioning apparatus as claimed in claim 1, wherein the guide is a positioning robot.

9. The patient positioning apparatus as claimed in claim 1, wherein the drive is iteratively activated.

10. The patient positioning apparatus as claimed in claim 9, wherein the drive is activated at regular intervals.

11. The patient positioning apparatus as claimed in claim 6, wherein the manual force is measured at regular intervals.

12. A method for positioning a patient bed, the method comprising:
measuring a manual force acting on the patient bed; and
moving the patient bed with a motorized device as a function of the measured manual force.

13. The method as claimed in claim 12, wherein measuring includes measuring with a sensor that is operable to detect a relative force between the motorized device and the patient bed.

14. The method as claimed in claim 13, wherein the sensor is a strain gage.

15. The method as claimed in claim 13, wherein moving the patient bed with a motorized device includes moving the patient bed with a motorized device only when a threshold value of the manual force acting on the patient bed is exceeded.

16. The method as claimed in claim 13, wherein moving the patient bed with a motorized device includes moving the motorized device so that the force between a drive axis and the patient bed is below a predetermined tolerance value.
